(19) United States
(12) Patent Application Publication
(10) Pub. No.: US 2020/0398347 A1
(43) Pub. Date: Dec. 24, 2020

(54) NUMERICAL CONTROL MACHINE AND CUTTING METHOD

(71) Applicant: CITIC Dicastal CO., LTD., Qinhuangdao (CN)

(72) Inventors: Weimin CAI, Qinhuangdao (CN); Jiandong GUO, Qinhuangdao (CN); Xiaoguang HUANG, Qinhuangdao (CN); Minghua LIU, Qinhuangdao (CN); Xiao LIU, Qinhuangdao (CN); Yao ZHENG, Qinhuangdao (CN); Yajun WANG, Qinhuangdao (CN)

(21) Appl. No.: 16/568,843

(22) Filed: Sep. 12, 2019

(30) Foreign Application Priority Data
Jun. 20, 2019 (CN) 201910538974.8

(51) Int. Cl. B23B 7/12; G05B 19/19

(52) U.S. Cl. CPC B23B 7/12; G05B 19/19

(57) ABSTRACT

The present disclosure provides a numerical control machine and a cutting method. The numerical control machine includes a workpiece seat for fixing a workpiece, a cutting tool, a non-contact measurement component for measuring a contour of a surface to be machined of the workpiece, a power component and a control component. The workpiece seat is rotatable relative to the cutting tool or the non-contact measurement component under driving of the power component, and/or the cutting tool is rotatable relative to the workpiece seat under the driving of the power component. Both the cutting tool and the non-contact measurement component are mounted on the numerical control machine, and distances from the workpiece seat to both is adjustable. The control component is electrically connected with the non-contact measurement component and the power component.

### CROSS-REFERENCE TO RELATED APPLICATION

The present application claims priority to Chinese Patent Application No. 201910538974.8, filed on Jun. 20, 2019, the contents of which are hereby incorporated by reference in their entirety.

### BACKGROUND

At present, fine turning of a front surface of an aluminum alloy rim, which is also known as an aluminum alloy wheel hub (hereinafter referred to as a workpiece), is performed by adopting a theoretical machining line. That is, regardless of a machining allowance of a workpiece, the workpiece is turned to a specified dimension. In order to ensure that all blank front surfaces are turned, namely the turned surfaces need to be exposed without retaining semifinished surfaces, and thus the specified dimension is generally a lower limit of an allowable deviation. In this way, the turning amount of each workpiece may be possibly different, and the turning amounts of parts of the workpieces with large machining allowances are very large. However, the relatively large turning amount will cause quality problems such as large burrs on a surface to be machined of the workpiece and high surface roughness, and the adhesion of a paint film will be affected, and paint-broken wastes are easily produced; and furthermore, the wear to a cutting tool is aggravated, which further affects the machining quality of the workpiece.

### SUMMARY

The present disclosure relates to a casting machining technology and particularly to a numerical control machine and a cutting method.

In view of above, the embodiment of the present disclosure is to provide a numerical control machine and a cutting method, which can decrease a workpiece machining amount, improve the quality of a workpiece and reduce the wear to a cutting tool.

In order to achieve the above objective, the technical solution of the embodiment of the present disclosure is realized as follows.

The embodiment of the present disclosure provides a numerical control machine. The numerical control machine includes a workpiece seat for fixing a workpiece, a cutting tool, a non-contact measurement component for measuring a contour of a surface to be machined of the workpiece, a power component and a control component. The workpiece seat is rotatable relative to the cutting tool or the non-contact measurement component under driving of the power component, and/or the cutting tool is rotatable relative to the workpiece seat under the driving of the power component. Both the cutting tool and the non-contact measurement component are mounted on the numerical control machine, and distances from the workpiece seat to both is adjustable. The control component is electrically connected with the non-contact measurement component and the power component.

In the above solution, the numerical control machine may further include a cutter head. The cutter head includes a connection end connected to the machine and a mounting end for mounting the cutting tool. Both the cutting tool and the non-contact measurement component are mounted to the mounting end of the cutter head. A preset distance is reserved between the cutting tool and the non-contact measurement component at the mounting end of the cutter head. The cutter head is movable relative to the workpiece seat under the driving of the power component. The cutter head and the cutting tool are respectively connected with the power component.

In the above solution, the workpiece seat may include a base plate, a locating component and a clamping component. The base plate includes a fixed end mounted on the numerical control machine and a clamping end for receiving the locating component and the clamping component. The locating component and the clamping component are detachably mounted to the clamping end.

In the above solution, the locating component may include a mandrel inserted into a center hole of the workpiece and a locating block abutting against an outer side wall of the workpiece. The axis of the mandrel is separated from the locating block by a preset distance.

In the above solution, the non-contact measurement component is a laser sensor.

The embodiment of the present disclosure further provides a cutting method. The method includes:

measuring a preset portion of a surface to be machined of a workpiece through a non-contact measurement component;

fitting out a contour of the surface to be machined of the workpiece according to measured data of the non-contact measurement component;

obtaining a cutting tool feeding route of a preset cutting amount according to the contour; and

controlling the cutting tool to cut the workpiece according to the cutting tool feeding route.

In the above solution, the measuring of a preset portion of a surface to be machined of a workpiece through a non-contact measurement component includes:

dividing the surface to be machined into a preset number of measurement regions, and measuring a distance between any one point in each measurement region and the non-contact measurement component.

In the above solution, the fitting out of a contour of the surface to be machined of the workpiece according to measured data of the non-contact measurement component includes:

fitting out the contour of the surface to be machined of the workpiece according to distance data, acquired by the non-contact measurement component, between all the measurement regions and the non-contact measurement component.

According to the numerical control machine and the cutting method of the embodiments of the disclosure, the numerical control machine includes the workpiece seat for fixing the workpiece, the cutting tool, the non-contact measurement component for measuring the contour of the surface to be machined of the workpiece, the power component and the control component; the workpiece seat is rotatable relative to the cutting tool or the non-contact measurement component under the driving of the power component, and/or the cutting tool is rotatable relative to the workpiece seat under the driving of the power component; both the cutting tool and the non-contact measurement component are mounted on the numerical control machine, and distances from the workpiece seat to both is adjustable; and the control component is electrically connected with the non-contact measurement component and the power component. Therefore, the numerical control machine and the cutting method of the embodiments of the present disclosure may decrease the workpiece machining amount, improve the quality of the workpiece and reduce the wear to the cutting tool by measuring the contour of the surface to be machined and determining the feeding route of the cutting tool according to the measured data.

Other beneficial effects of the embodiments of the present disclosure will be further described with reference to specific technical solutions in the specific implementations.

### BRIEF DESCRIPTION OF THE DRAWINGS

In order to describe the technical solutions in the embodiments of the present disclosure more clearly, drawings used in the descriptions of the embodiments are briefly described below. It should be understood that the drawings described below are only a part of the drawings of the embodiments of the present disclosure, and those skilled in the art can obtain other drawings according to these drawings without any creative work.

FIG. 1 is an outline schematic diagram I of a numerical control machine according to the embodiment of the present disclosure (a non-contact measurement component is in measurement);

FIG. 2 is an outline schematic diagram II of a numerical control machine according to the embodiment of the present disclosure (a cutting tool is in cutting);

FIG. 3 is a schematic diagram of an internal structure of the numerical control machine according to the embodiment of the present disclosure;

FIG. 4 is a flowchart of a cutting method according to the embodiment of the present disclosure;

FIG. 5 is a schematic diagram of an automotive rim in a numerical control machine according to the embodiment of the present disclosure;

FIG. 6 is a schematic diagram of automotive rim along A in FIG. 5; and

FIG. 7 is a schematic diagram of a cutting tool feeding route in a numerical control machine according to the embodiment of the present disclosure.

### DETAILED DESCRIPTION OF THE EMBODIMENTS

It should be noted that in the embodiments of the present disclosure, unless otherwise stated and specified, the term “connect” or “connection” shall be of a general understanding. For example, it may be electrical connection, internal connection between two elements, direct connection or indirect connection through an intermediate. The ordinary skilled in the art may understand specific meanings of the above terms according to specific situations. The term “first”, “second”, or “third” as used in the embodiments of the present disclosure is only to distinguish similar objects and does not represent a specific order of the objects. It can be understood that specific orders or successive orders of “first”, “second”, or “third” may be interchanged where permitted.

The embodiment of the present disclosure provides a numerical control machine. The numerical control machine includes a workpiece seat for fixing a workpiece, a cutting tool, a non-contact measurement component for measuring the contour of a surface to be machined of the workpiece, a power component and a control component. The workpiece seat is rotatable relative to the cutting tool or the non-contact measurement component under the driving of the power component, and/or the cutting tool is rotatable relative to the workpiece seat under the driving of the power component. Both the cutting tool and the non-contact measurement component are mounted on the numerical control machine, and distances from the workpiece seat to both is adjustable. The control component is electrically connected with the non-contact measurement component and the power component.

Herein, the numerical control machine is a numerical control lathe, and the workpiece seat is rotatable relative to the cutting tool or the non-contact measurement component under the driving of the power component. In another embodiment, the numerical control machine can be a numerical control milling machine, and the cutting tool is rotatable relative to the workpiece seat under the driving of the power component. In still another embodiment, the numerical control machine can be a multifunctional machine such as a machining center, and both the workpiece and the cutting tool are rotatable.

The numerical control machine of the embodiment of the present disclosure may decrease the workpiece machining amount, improve the quality of the workpiece and reduce the wear to the cutting tool by measuring the contour of the surface to be machined and determining the feeding route of the cutting tool according to the measured data.

In an implementation, the numerical control machine further includes a cutter head. The cutter head includes a connection end connected to the machine and a mounting end for mounting the cutting tool. Both the cutting tool and the non-contact measurement component are mounted to the mounting end of the cutter head. A preset distance is reserved between the cutting tool and the non-contact measurement component at the mounting end of the cutter head. The cutter head is movable relative to the workpiece seat under the driving of the power component. The cutter head and the cutting tool are respectively connected to the power component. The cutter head is a commonly used preferred form of a common numerical control machine. Due to the cutter head, multiple cutting tools may be simultaneously mounted on the numerical control machine, and cutting tool replacement is controlled through a program, so that the machining continuity is higher, and the efficiency is higher. In the present embodiment, the cutter head may be used as a mounting position for the non-contact measurement component, and the non-contact measurement component may be mounted on the cutter head like an ordinary tool.

Herein, the cutter head and the cutting tool are respectively connected with the power component, that is, the cutting tool and the cutter head is movable independently. The cutter head is used to adjust the position of the cutting tool relative to the workpiece seat, i.e., to control a cutting amount. The cutting tool rotates as required during machining and does a cutting motion. The power component of the embodiment of the present disclosure is a general term. Actually, the workpiece seat, the cutter head and the cutting tool all have independent power components.

The objective of reserving the preset distance between the cutting tool and the non-contact measurement component at the mounting end of the cutter head is to: prevent the non-contact measurement component from affecting the cutting of the cutting tool.

In an implementation, the workpiece seat includes a base plate, a locating component and a clamping component. The base plate includes a fixed end mounted on the numerical control machine and a clamping end for receiving the locating component and the clamping component. The locating component and the clamping component are detachably mounted to the clamping end. In this way, fast locating may be realized, and correction is performed without the help of other components such as a dial indicator. This is a preferred mode. The clamping component herein may be generally a pressing plate.

In an implementation, the locating component includes a mandrel inserted into a center hole of the workpiece and a locating block abutting against the outer side wall of the workpiece. The axis of the mandrel is separated from the locating block by a preset distance. In this way, more accurate locating is achieved, and this is a preferred mode. The axis of the mandrel is separated from the locating block by a preset distance means that: the distance therebetween is set according to the dimension of the workpiece to make the locating more accurate.

In an implementation, the non-contact measurement component is a laser sensor. The laser sensor is a sensor for measurement using a laser technology. It is composed of a laser device, a laser detector and a measurement circuit. The laser sensor is a novel measurement instrument and has the advantages of capability of realizing non-contact remote measurement, high speed, high precision, large measurement range, high optical and electrical interference resistance and the like. It is a preferred mode to use the laser sensor which is an optical sensor. It can be understood that the laser sensor may also be other sensors, such as a sensor for measurement through an electromagnetic principle.

The embodiment of the present disclosure further provides a cutting method. The method includes that:

measuring a preset portion of a surface to be machined of a workpiece through a non-contact measurement component;

fitting out a contour of the surface to be machined of the workpiece according to measured data of the non-contact measurement component;

obtaining a cutting tool feeding route of a preset cutting amount according to the contour; and

controlling the cutting tool to cut the workpiece according to the cutting tool feeding route.

Herein, during measurement, the workpiece may rotate or move, and the non-contact measurement component is fixed. Or, the workpiece may be fixed, and the non-contact measurement component rotates or moves. The preset portion may be multiple regions on the surface to be machined. The contour of the surface to be machined may be obtained by measuring the plurality of regions. If more regions are provided, the obtained contour is more accurate.

Herein, the cutting tool feeding route of the preset cutting amount is a cutting tool feeding route of a minimum cutting amount. Since the contour is obtained, the cutting tool feeding route of the minimum cutting amount may be obtained. In the conventional machining, in order to ensure that every part of the surface to be machine may be cut, namely the “turning” in the factory is realized, it is necessary to set a large enough cutting amount. In this way, the dimension often has reached a lower limit of an allowable deviation after cutting, which not only causes a large cutting amount, but also makes the surface of the machined surface rougher and the cutting tool more prone to wear.

Herein, the allowable deviation of the dimension also may be a contour tolerance in addition to the consideration of a dimension tolerance.

The minimum cutting amount of the embodiment of the present disclosure is determined according to the contour of the machined surface of each workpiece and the specified dimension of the workpiece. If only the “turning” may conform to the specified dimension of the workpiece, the “turning” is directly performed, or the cutting amount is increased till an upper limit of the specified dimension of the workpiece is satisfied. For example, if the contour of the machined surface of a certain workpiece is uneven, the feeding route of the cutting tool may be possibly a curve. Of course, in order to ensure that the cut contour conforms to the contour tolerance, the curve and the contour of the machined surface are different. Generally, the ups and downs degree of the curve of the feeding route is smaller, so as to conform to the contour tolerance. In this way, the size is often close to the upper limit of the allowable deviation after cutting. In this way, the workpiece machining amount may be reduced, the quality of the workpiece may be improved, and the wear to the cutting tool may be relieved. The method may be known as an adaptive machining method.

In an implementation, measuring the preset portion of the surface to be machined of the workpiece through the non-contact measurement component includes that:

dividing the surface to be machined into a preset number of measurement regions, and measuring a distance between any point in each measurement region and the non-contact measurement component.

The preset number of the measurement regions is to guarantee enough measurement regions. Any point in each measurement region may represent the situation of the measurement region. That is, if more measurement regions are provided, a measurement result is more accurate. Therefore, a proper number of measurement regions may be actually preset according to machining requirements and the size of the workpiece.

In an implementation, fitting out a contour of the surface to be machined of the workpiece according to measured data of the non-contact measurement component includes that:

fitting out the contour of the surface to be machined of the workpiece according to distance data, acquired by the non-contact measurement component, between all the measurement regions and the non-contact measurement component.

Specifically, the distance between each measurement region and the non-contact measurement component is used as one point, and multiple points are connected to form a line and then a plane. The points of the distances between all the measurement regions and the non-contact measurement component may be fitted into the contour of the surface to be machined of the workpiece. The fitted contour herein is an approximate contour. The fitting is to smoothly connect points at different distances. In case of enough points, the fitted contour of the surface to be machined of the workpiece is very close to the actual contour.

The present disclosure is further described in detail below in combination of the drawings and specific embodiments. It should be understood that the specific embodiments described herein are merely explanatory of the present disclosure and are not intended to limit the present disclosure. Furthermore, the embodiments described below are only a part of the embodiments of the present disclosure, but not all the embodiments. All other embodiments obtained by the ordinary skilled in the art according to these embodiments without any creative work fall within the protection scope of the present disclosure.

### First Embodiment

The embodiment of the present disclosure provides a numerical control lathe. The numerical control lathe is used for machining an automotive rim 10. It can be understood that the structure and principle of the numerical control lathe of the embodiment of the present disclosure may also be applied to other numerical control machines and may also be used for machining other parts.

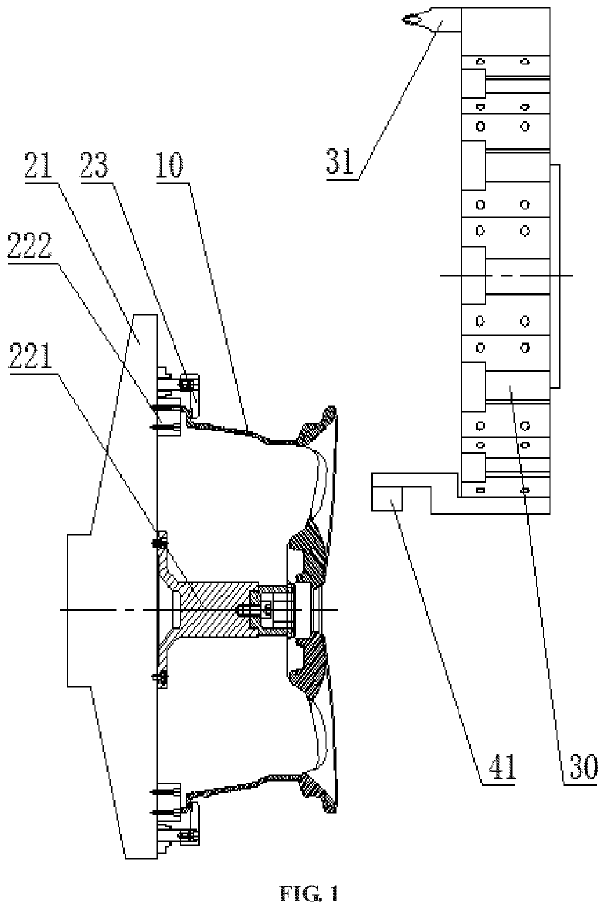

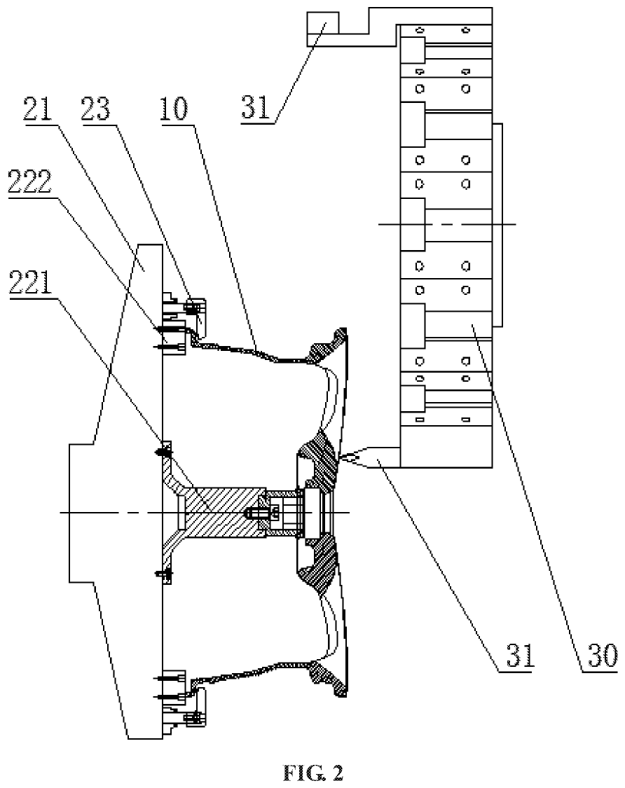

Referring to FIG. 1 and FIG. 2, the numerical control machine includes a workpiece seat, a cutting tool 31, a non-contact measurement component, a power component and a control component.

The workpiece seat is used for fixing the automotive rim 10.

The cutting tool 31 is used for cutting the automotive rim 10.

The non-contact measurement component is used for measuring a contour of a surface to be machined of the automotive rim 10, namely acquiring data. In order to make the measured data more accurate, the non-contact measurement component may adjust a distance relative to the workpiece seat.

The power component is used for driving the workpiece seat to rotate relative to the cutting tool 31 or the non-contact measurement component.

The control component is used for processing the measured data of the non-contact measurement component and controlling the power component to operate. The control component is electrically connected with the non-contact measurement component and the power component. The control component may be a single-chip microcomputer installed in the numerical control machine, may also be an ordinary computer or an industrial computer and may also be other sets of intelligent equipment.

In the present embodiment, the numerical control machine further includes a cutter head 30. The cutter head 30 includes a connection end connected to the machine and a mounting end for mounting the cutting tool 31. Both the cutting tool 31 and the non-contact measurement component are mounted to the mounting end of the cutter head 30. The non-contact measurement component may be mounted on the cutter head 30 like an ordinary tool. In order to reduce the mutual interference as much as possible, the cutting tool 31 and the non-contact measurement component are separately located at two symmetric sides of the cutter head 30. The cutter head 30 is movable relative to the workpiece seat under the driving of the power component, and the cutter head 30 is connected with the power component.

In the present embodiment, the workpiece seat includes a base plate 21, a locating component and a clamping component 23. The base plate 21 includes a fixed end mounted on the numerical control machine and a clamping end for receiving the locating component and the clamping component 23. The locating component and the clamping component 23 are detachably mounted to the clamping end. Specifically, the base plate 21 is fixed to a main shaft of the lathe. The locating component includes a mandrel 221 inserted into a center hole of the automotive rim 10 and a locating block 222 abutting against the outer side wall of the automotive rim 10. This is decided by the fact that the workpiece to be machined is the automotive rim 10 since the automotive rim 10 is circular and has the center hole in the middle. Through the mandrel 221 and the locating block 222, this is the simplest and most reliable locating mode.

In the present embodiment, the non-contact measurement component is a laser sensor 41. The laser sensor 41 may realize non-contact remote measurement and has the advantages of high speed, high precision, large measurement range, high optical and electrical interference resistance and the like.

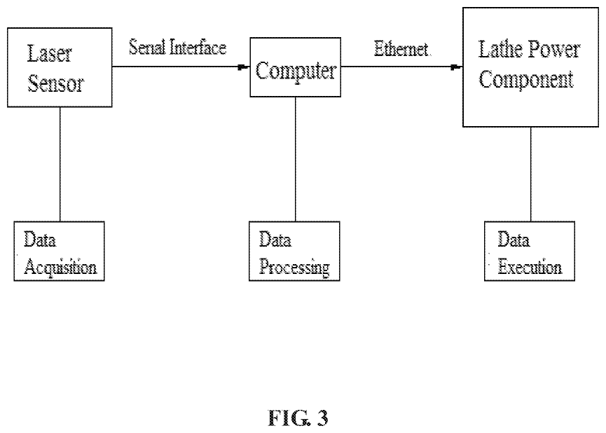

In order to learn about the principle of the present embodiment more clearly, the internal structure of the present embodiment and a data transmission process are described below. Referring to FIG. 3, the numerical control lathe includes a laser sensor, a computer and a lathe power component.

The laser sensor is used for acquiring data.

The computer is used for processing the data. The computer is equivalent to the above control component.

The lathe power component is used for executing the data, namely driving the workpiece seat, the cutting tool 31 and the cutter head 30 according to the data.

The laser sensor is connected to the computer through a serial interface. The computer is connected to the lathe power component through an Ethernet. Actually, in addition to the computer, the lathe also includes a control device for controlling a series of components: the power component, cooling fluid and a lighting lamp. Therefore, the connection herein between the computer and the lathe power component is realized through the control device. The computer herein may be mounted on the lathe, or the computer, independent of the lathe, is only used for processing the data of the laser sensor and may be shared by multiple lathes.

It can be understood that the serial interface or Ethernet is a preferred connection mode, but other connection modes may also be used, and even a wireless connection mode is used. Detailed descriptions are omitted.

### Second Embodiment

The present embodiment provides a cutting method. The method is performed by a control component. A product to be cut is an automotive rim 10, and the specific shape is as shown in FIGS. 1 and 2. It can be understood that the cutting method in the present embodiment is also applicable to other parts.

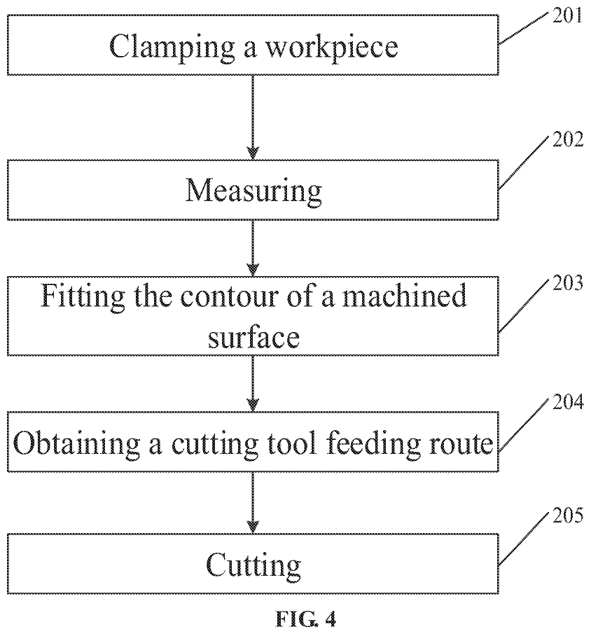

Referring to FIG. 4, the method includes that:

Step 201: clamping a workpiece. Fixing the automotive rim 10 on the workpiece seat.

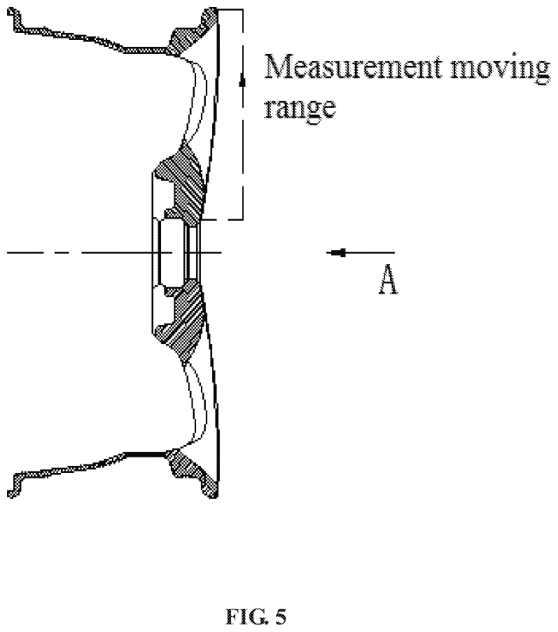

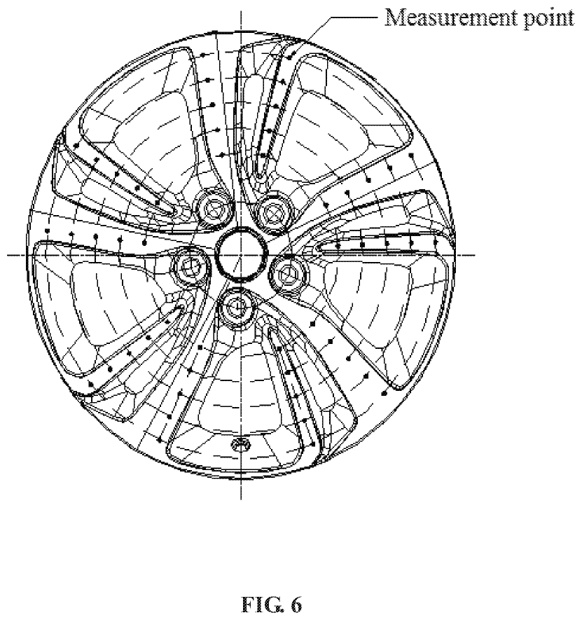

Step 202: performing the measurement. Driving the workpiece seat to rotate, namely, driving the automotive rim 10 to rotate, and meanwhile, moving the laser sensor 41 to a preset position for measurement. A measurement range and position are as shown in FIGS. 5 and 6. Specifically, the surface to be machined, namely the end surface, of the automotive rim 10 may be divided into longitude lines and latitude lines to form multiple measurement regions (since the end surface of the automotive rim 10 has many hollows, the longitude lines are not shown). Referring to FIG. 6, the laser sensor 41 measures each measurement region except the hollows, namely measures a distance between each measurement region and the laser sensor 41. Specifically, a distance between a measurement point of each measurement region and the laser sensor 41 is measured. During the measurement, the laser sensor 41 needs to be moved in a radial direction, referring to a measurement moving range in FIG. 5. The laser sensor 41 is moved by moving the cutter head 30.

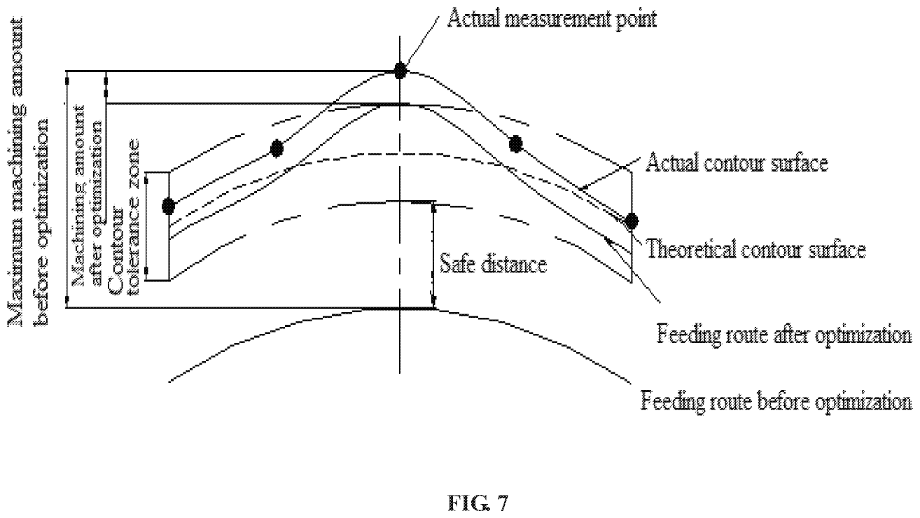

Step 203: fitting out a contour of the machined surface. The distance value, obtained in Step 202, between each measurement region and the laser sensor 41 is smoothly connected to fit out an approximate contour of the machined surface. Referring to FIG. 7, it can be seen from FIG. 7 that in the conventional machining, the workpiece is machined only according to a “theoretical contour surface” without measurement, and thus, in order to guarantee the “turning”, a “safe distance” needs to be set (because an actual contour is uneven). Therefore, the cutting amount is very large if the machining is performed according to a “feeding route before optimization”, but the “actual contour surface” is obtained after the measurement of multiple “actual measurement points”. Therefore, by the “actual contour surface”, no safe distance needs to be set, and the cutting amount after optimization is very small. Every point is different in machining amount before optimization. The machining amount of the highest point is the largest. That is, the maximum machining amount before optimization is very large, while the “machining amount after optimization” is the same at every point, and the cutting amount is very small.

Step 204: obtaining a cutting tool feeding route. The cutting tool feeding route of a preset cutting amount is obtained according to the contour and a minimum cutting amount, referring to FIG. 7.

Step 205: performing the cutting. The cutting tool 31 is controlled to cut the workpiece according to the cutting tool feeding route.

The above are only the preferred embodiments of the present disclosure and are not intended to limit the protection scope of the present disclosure. Any modifications, equivalent replacements and improvements made within the spirit and principle of the present disclosure shall fall within the protection scope of the present disclosure.

1. A numerical control machine, comprising a workpiece seat for fixing a workpiece, a cutting tool, a non-contact measurement component for measuring a contour of a surface to be machined of the workpiece, a power component and a control component, wherein the workpiece seat is rotatable relative to the cutting tool or the non-contact measurement component under driving of the power component, and/or the cutting tool is rotatable relative to the workpiece seat under the driving of the power component; both the cutting tool and the non-contact measurement component are mounted on the numerical control machine, and distances from the workpiece seat to both is adjustable; and the control component is electrically connected with the non-contact measurement component and the power component.

2. The numerical control machine according to claim 1, further comprising a cutter head, wherein the cutter head includes a connection end connected to the machine and a mounting end for mounting the cutting tool; both the cutting tool and the non-contact measurement component are mounted to the mounting end of the cutter head; a preset distance is reserved between the cutting tool and the non-contact measurement component at the mounting end of the cutter head; the cutter head is movable relative to the workpiece seat under the driving of the power component; and the cutter head and the cutting tool are respectively connected to the power component.

3. The numerical control machine according to claim 2, wherein the workpiece seat comprises a base plate, a locating component and a clamping component; the base plate includes a fixed end mounted on the numerical control machine and a clamping end for receiving the locating component and the clamping component; and the locating component and the clamping component are detachably mounted to the clamping end.

4. The numerical control machine according to claim 3, wherein the locating component comprises a mandrel inserted into a center hole of the workpiece and a locating block abutting against an outer side wall of the workpiece; and the axis of the mandrel is separated from the locating block by a preset distance.

5. The numerical control machine according to claim 1, wherein the non-contact measurement component is a laser sensor.
